(19) United States
(12) Patent Application Publication
(10) Pub. No.: US 2011/0013499 A1
(43) Pub. Date: Jan. 20, 2011

(54) RECORDING APPARATUS AND METHOD, AND COMPUTER PROGRAM

(75) Inventors: Hideyuki Muto, Edogawaku (JP); Shogo Miyanabe, Higashiyamato-shi (JP); Yoshio Sasaki, Tokorozawa-shi (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa (JP)

(21) Appl. No.: 12/934,760

(22) PCT Filed: Apr. 1, 2008
(86) PCT No.: PCT/JP2008/056484

§ 371 Date: Sep. 27, 2010

(51) Int. Cl. G11B 20/00

(52) U.S. Cl. 369/53.44; G9B/20

(57) ABSTRACT

A recording apparatus (1) is provided with: a detecting device (21) for detecting an appearance frequency of at least one of a signal component of a plurality of types of marks and a signal component of a plurality of types of spaces which have different run lengths and which are included in a read signal read from a recording medium (100) and which have different run lengths which are included in the read signal and which have different run lengths; and a judging device (22) for judging whether or not a jitter obtained from the read signal is effective, on the basis of a change amount of the appearance frequency.

### TECHNICAL FIELD

The present invention relates to a recording apparatus for and method of recording a data pattern onto a recording medium, and a computer program which makes a computer function as such a recording apparatus.

### BACKGROUND ART

As this type of recording apparatus, there are realized various equipments for recording a data pattern by applying a laser beam onto a recording medium, such as a CD, a DVD, and a Blu-ray Disc. In such a recording apparatus, a data pattern formed of a mark and a space is recorded onto the recording medium by applying the laser beam onto a track on the recording medium. This allows the recording of the data pattern.

In such a recording apparatus, the recording power, recording pulse width, and the like of a recording laser beam are adjusted. For example, in the configuration disclosed in a patent document 1, an optimum recording power is calculated on the basis of a jitter obtained by recording a test-writing data pattern and reproducing the recorded data pattern while the recording power is changed. Moreover, in the configuration disclosed in a patent document 2, the optimum recording power is calculated on the basis of a change in an envelope waveform, error rate, asymmetry, jitter, or the like obtained by recording a test-writing data pattern and reproducing the recorded data pattern while the recording power is changed. Moreover, in the configuration disclosed in a patent document 1, the power, pulse width, and the like of the recording laser beam are adjusted so as to make a small difference between the probability of appearance of each code in the data pattern recorded on the recording medium and the probability of appearance of each code in a reproduction signal obtained by reproducing the data pattern.
Patent document 1: Japanese Patent Application Laid Open No. 2002-74668
Patent document 2: Japanese Patent Application Laid Open No. 2000-251254
Patent document 3: Japanese Patent Application Laid Open No. 2007-242149

### DISCLOSURE OF INVENTION

### Subject to be Solved by the Invention

However, the study of the present inventors has showed that the optimum recording power cannot be always obtained by the adjustment of the power based on the jitter. For example, in the configuration that the test-writing data pattern is recorded while the recording power is changed, it is necessary to change the recording power from a relatively high recording power to a relatively low recording power. Thus, if the data pattern is recorded with the relatively low recording power, the amount of energy given to the recording medium is absolutely short, which likely makes it hard to record a mark with a relatively short run length. As a result, for example, a mark which is supposed to be recorded such that the run length is 2T or 3T is likely recorded as a mark with a run length of 2T or less than 3T. In this case, in the reproduction, the signal component of the mark with a run length of 2T or less than 3T likely does not cross a zero level (or a binary slice level). As a result, the mark with a run length of 2T or less than 3T does not contribute to the calculation of the jitter and no longer deteriorates the jitter. Therefore, in spite of the recording power in which the jitter is supposed to be deteriorated under normal circumstances, it is recognized as if a good jitter were obtained. Therefore, the configuration disclosed in the patent document 1 and the patent document 2 described above includes such a technical problem that the optimum recording power cannot be always obtained because the recording power is also adjusted with reference to a so-called less reliable jitter.

Moreover, the recognition as if the good jitter were obtained not only in the calculation of the optimum recording power but also in the reproduction of the data although the data in which the jitter is supposed to be deteriorated is recorded, is far from being preferable in terms of a good recording operation or reproduction operation.

In view of the aforementioned problems, it is therefore an object of the present invention to provide a recording apparatus and method, and a computer program which can preferably judge whether or not the jitter of a data pattern recorded on a recording medium is effective.

### Means for Solving the Subject

The above object of the present invention can be achieved by a recording apparatus provided with: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging device for judging whether or not a jitter obtained from the read signal is effective, on the basis of a change amount of the appearance frequency of the at least one signal component.

The above object of the present invention can be also achieved by a recording method provided with: a detecting process of detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging process of judging whether or not a jitter obtained from the read signal is effective, on the basis of a change amount of the appearance frequency of the at least one signal component.

The above object of the present invention can be also achieved by a computer program for recording control and for controlling a computer provided in a recording apparatus comprising: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging device for judging whether or not a jitter obtained from the read signal is effective, on the basis of a change amount of the appearance frequency of the at least one signal component, the computer program making the computer function as said detecting device and said judging device.

The operation and other advantages of the present invention will become more apparent from the embodiments explained below.

### BRIEF DESCRIPTION OF DRAWINGS

FIG. 1 is a block diagram conceptually showing the basic structure of a recording/reproducing apparatus in an example.

FIG. 2 is a flowchart conceptually showing a flow of operations of the recording/reproducing apparatus in the example.

FIG. 3 is a schematic diagram conceptually showing an operation of recording an OPC pattern.

FIG. 4 are tables showing the reference frequency of each mark and each space.

FIG. 5 is a graph showing a correlation between a recording power and each of jitter and the appearance frequency of the shortest mark.

FIG. 6 is a graph showing the conditions of a read signal obtained by reproducing a data pattern recorded with various recording powers, with a binary slice level.

FIG. 7 are views showing the appearance frequency of each mark and each space recorded with a normal recording power and a relatively low recording power.

FIG. 8 is a graph showing the appearance frequency of the space recorded with the normal recording power and the relatively low recording power.

FIG. 9 is a graph showing the appearance frequency of the mark recorded with the normal recording power and the relatively low recording power.

FIG. 10 is a graph showing a difference in the appearance frequency between a space with a run length of 9T and a space with a run length of 9T in a sync pattern recorded with the normal recording power and the relatively low recording power.

FIG. 11 is a block diagram conceptually showing the structure of a recording/reproducing apparatus in a modified example.

### DESCRIPTION OF REFERENCE CODES

1, 2 recording/reproducing apparatus
10 spindle motor
11 pickup
12 HPF
13 A/D converter
14 pre equalizer
15 limit equalizer
16 binary circuit
17 decoding circuit
21 T frequency detection circuit
22 reliability judgment circuit
23 jitter detection circuit
24 OPC processing circuit
25 CPU

### BEST MODE FOR CARRYING OUT THE INVENTION

As the best mode for carrying out the invention, embodiments of the recording apparatus and method, and the computer program of the present invention will be explained.

### Embodiment of Recording Apparatus

An embodiment of the recording apparatus of the present invention is provided with: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging device for judging whether or not a jitter obtained from the read signal is effective, on the basis of a change amount of the appearance frequency of the at least one signal component.

According to the embodiment of the recording apparatus of the present invention, the appearance frequency of at least one of the signal component of the plurality of types of marks and the signal component of the plurality of types of spaces is detected by the operation of the detecting device. For example, if the recording medium is a DVD, marks with run lengths of 3T to 11T and 14T are listed as one example of the “plurality of types of marks”. In the same manner, if the recording medium is a Blu-ray Disc, marks with run lengths of 2T to 9T are listed as one example of the “plurality of types of marks”. If the recording medium is a DVD, spaces with run lengths of 3T to 11T and 14T are listed as one example of the “plurality of types of spaces”. In the same manner, if the recording medium is a Blu-ray Disc, spaces with run lengths of 2T to 9T are listed as one example of the “plurality of types of spaces”.

Then, by the operation of the judging device, it is judged whether or not the jitter obtained from the read signal is effective, on the basis of the change amount of the appearance frequency detected by the detecting device (e.g. the change amount of the appearance frequency itself, the change amount with respect to a predetermined reference frequency, a difference from the predetermined reference frequency, a magnitude relation with respect to the predetermined reference frequency, a ratio with respect to the predetermined reference frequency, a rate of deviation with respect to the predetermined reference frequency, or the like). In other words, it is judged whether or not the jitter obtained from the read signal including at least one signal component in which the appearance frequency is detected by the detecting device is effective (in other words, reliable). Here, the “reference frequency” may indicate, for example, a fixed value determined in advance, an appearance frequency of each of the plurality of types of marks and the plurality of types of spaces in a case where a normal recording operation is performed, and the like.

Here, depending on a recording power when the data pattern is recorded, the mark with an originally intended run length is likely unable to be recorded as described above. For example, if the recording power when the data pattern is recorded is relatively low, the mark which is supposed to be recorded as the mark with a run length of minT is likely recorded as the mark with a run length of less than minT (wherein “minT” indicates the shortest run length determined in advance by the standard of the recording medium), due to energy shortage in a laser beam applied to the recording medium. The recording of the mark with a run length of less than minT causes the reading of the space with a run length of less than minT together with the mark with a run length of less than minT in the reproduction. Moreover, in the reproduction, if the signal component of the mark or space with a run length of less than minT is shifted in an amplification direction, it may no longer cross a zero level (or a binary slice level). This results in the reproduction of the data pattern which is supposed to be recorded as the mark and space with a predetermined run length, as a series of spaces. If such a space is connected to the mark and space with another run length, it may change the run length of the mark and space with another run length. On the other hand, in this case, the signal component of the mark or space with a run length of less than minT does not cross the zero level (or the binary slice level), so that the jitter of the read signal does not deteriorate. Thus, although the jitter is supposed to deteriorate because the data pattern is recorded in a different condition from an originally intended condition, the jitter obtained in the actual reproduction has a good value. However, according to the embodiment, it can be judged whether or not the jitter is effective, in view of the change amount of the appearance frequency of the signal component of each mark or the signal component of each space described above. In other words, even if the jitter has a good value, it can be judged whether or not the jitter is effective (i.e. reliable) on the basis of the change amount of the appearance frequency of the signal component of each mark or the appearance frequency of the signal component of each space.

As described above, according to the recording apparatus in the embodiment, when the jitter is detected, it can be preferably judged whether or not the jitter is effective by referring to the appearance frequency of at least one signal component of the plurality of types of marks and the plurality of types of spaces with different run lengths. Therefore, without being bound only by the value of the jitter, it can be preferably judged whether or not the jitter of the data pattern recorded on the recording medium is effective. As a result, it is possible to improve the detection accuracy of the jitter, in comparison with the configuration that the obtained jitter is used for the recording process or reproduction process as it is.

In one aspect of the embodiment of the recording apparatus of the present invention, the recording apparatus is further provided with a recording device for recording a test-writing data pattern onto the recording medium while changing a recording power, the detecting device detects an appearance frequency of at least one of a signal component of a plurality of types of marks which are included in a read signal obtained by reading the test-writing data pattern and which have different run lengths and a signal component of a plurality of types of spaces which are included in the read signal and which have different run lengths, with each of the changed recording power, the recording apparatus further comprises a calculating device for calculating an optimum recording power used when the recording device records the data pattern onto the recording medium, on the basis of a jitter which is judged to be effective.

According to this aspect, the optimum recording power can be calculated by selectively referring to an effective jitter (in other words, without selectively referring to an ineffective jitter). Therefore, in comparison with the configuration that the optimum recording power is calculated with reference to the obtained jitter as it is, the optimum recording power can be calculated, preferably or highly accurately.

In an aspect of the recording apparatus provided with the calculating device as described above, the calculating device may calculate a center value of a power margin as the optimum recording power, the power margin being a range of the recording power with which the test-writing data pattern is recorded, the jitter which is judged to be effective and which is less than or equal to an allowable value being obtained in the power margin.

By virtue of such configuration, the optimum recording power can be preferably calculated by selectively referring to the effective jitter (in other words, without selectively referring to the ineffective jitter).

In another aspect of the recording apparatus of the present invention, the detecting device detects an appearance frequency of a signal component of a mark with the shortest run length, and the judging device judges whether or not the jitter obtained from the read signal is effective, on the basis of a change amount of the appearance frequency of the signal component of the mark with the shortest run length.

According to this aspect, it can be judged whether or not the jitter is effective, on the basis of the appearance frequency of the mark with the shortest run length (e.g. a mark with a run length of 3T if the recording medium is a DVD, and a mark with a run length of 2T if the recording medium is a Blu-ray Disc) which is significantly influenced due to the relatively low recording power in the recording of the data pattern. Therefore, it can be judged whether or not the jitter is effectively, more highly accurately or more easily.

In another aspect of the embodiment of the recording apparatus of the present invention, the detecting device detects an appearance frequency of a signal component of a space with the shortest run length, and the judging device judges whether or not the jitter obtained from the read signal is effective, on the basis of a change amount of the appearance frequency of the signal component of the space with the shortest run length.

According to this aspect, it can be judged whether or not the jitter is effective, on the basis of the appearance frequency of the space with the shortest run length (e.g. a space with a run length of 3T if the recording medium is a DVD, and a space with a run length of 2T if the recording medium is a Blu-ray Disc) which is significantly influenced due to the relatively low recording power in the recording of the data pattern. Therefore, it can be judged whether or not the jitter is effective, more highly accurately or more easily.

In an aspect of the recording apparatus in which it is judged whether or not the jitter is effective on the basis of the change amount of the signal component of the mark or space with the shortest run length, the judging device may judge that the jitter obtained from the read signal is not effective if the appearance frequency is less than a predetermined reference frequency at a predetermined ratio or more.

As described above, due to the relatively low recording power in the recording of the data pattern, it is hardly possible to record the mark or space with the originally intended run length as described above. As a result, the mark or space to be recorded as the mark or space with the shortest run length is likely recorded as the mark or space with the shorter run length. This reduces the appearance frequency of the mark or space with the shortest run length. On the other hand, even in such a case, the situation that the jitter does not deteriorate can occur as described above. Therefore, it can be preferably judged whether or not the jitter is effective by judging that the jitter is not effective if the appearance frequency is less than the reference frequency at the predetermined ratio or more.

In another aspect of the embodiment of the recording apparatus of the present invention, the detecting device detects an appearance frequency of a signal component of a space with a relatively long run length included in the read signal, and the judging device judges whether or not the jitter obtained from the read signal is effective, on the basis of a change amount of the appearance frequency of the signal component of the space with the relatively long run length.

According to this aspect, it can be preferably judged whether or not the jitter is effective, on the basis of the appearance frequency of the signal component of the space with the relatively long run length (e.g. spaces with run lengths of 7T to 11T and 14T if the recording medium is a DVD, and spaces with run lengths of 6T to 9T if the recording medium is a Blu-ray Disc) in which the appearance frequency can be changed due to the reduction in the appearance frequency of the mark or space with the shortest run length.

In another aspect of the embodiment of the recording apparatus of the present invention, the detecting device detects an appearance frequency of a signal component of a space with the longest run length included in the read signal, and the judging device judges whether or not the jitter obtained from the read signal is effective, on the basis of a change amount of the appearance frequency of the signal component of the space with the longest run length.

According to this aspect, it can be preferably judged whether or not the jitter is effective, on the basis of the appearance frequency of the signal component of the space with the longest run length (e.g. a space with a run length of 11T or 14T if the recording medium is a DVD, and a space with run lengths of 8T or 9T if the recording medium is a Blu-ray Disc) in which the appearance frequency can be changed due to the reduction in the appearance frequency of the mark or space with the shortest run length.

In an aspect of the recording apparatus in which it is judged whether or not the jitter is effective on the basis of the change amount of the appearance frequency of the signal component of the space with the relatively long or longest run length, the judging device may judge that the jitter obtained from the read signal is not effective if the appearance frequency is greater than a predetermined reference frequency at a predetermined ratio or more.

As described above, due to the relatively low recording power in the recording of the data pattern, it is hardly possible to record the mark or space with the originally intended run length as described above. As a result, the mark or space to be recorded as the mark or space with the shortest run length is likely recorded as the mark or space with the shorter run length. Because of this, in the reproduction, it is likely treated as the data pattern in which the space with the shorter run length is connected to the space with the relatively long run length in a unified manner. This increases the appearance frequency of the space with the relatively long or longest run length. On the other hand, even in such a case, the situation that the jitter does not deteriorate can occur as described above. Therefore, it can be preferably judged whether or not the jitter is effective by judging that the jitter is not effective if the appearance frequency is greater than the reference frequency at the predetermined ratio or more.

In another aspect of the embodiment of the recording apparatus of the present invention, the detecting device detects an appearance frequency of a signal component of at least one signal component of a mark with a violated run length which is included in the read signal and which is different from a run length determined in advance by a standard and a space with the violated run length, and the judging device judges whether or not the jitter obtained from the read signal is effective, on the basis of a change amount of the appearance frequency of at least one signal component of the mark with the violated run length and the space with the violated run length.

According to this aspect, considering that the mark or space to be recorded as the mark or space with the shortest (or longest) run length is likely recorded as the mark or space with the shorter or longer run length (i.e. the violated run length: e.g. run lengths of 2T or less, 12T, 13T, 15T or more if the recording medium is a DVD, and run lengths of 1T or less, or 10T or more if the recording medium is a Blu-ray Disc), it can be preferably judged whether or not the jitter is effective.

In an aspect of the recording apparatus in which it is judged whether or not the jitter is effective on the basis of the change amount of the appearance frequency of at least one signal component of the mark and space with the violated run length, the judging device may judge that the jitter obtained from the read signal is not effective if the appearance frequency is greater than a predetermined reference frequency at a predetermined ratio or more.

As described above, due to the relatively low recording power in the recording of the data pattern, it is hardly possible to record the mark or space with the originally intended run length as described above. This increases the appearance frequency of the mark or space with the violated run length. On the other hand, even in such a case, the situation that the jitter does not deteriorate can occur as described above. Therefore, it can be preferably judged whether or not the jitter is effective by judging that the jitter is not effective if the appearance frequency is greater than the reference frequency at the predetermined ratio or more.

In another aspect of the embodiment of the recording apparatus of the present invention, a sync pattern is recorded on the recording medium, the sync pattern substantially equally including marks with a predetermined run length and spaces with the predetermined run length, the detecting device detects an appearance frequency of each of a signal component of the marks which are included in the read signal and which have the predetermined run length and a signal components of the spaces which are included in the read signal and which have the predetermined run length, and the judging device judges whether or not the jitter obtained from the read signal is effective, on the basis of a change amount of the appearance frequency of the signal component of the marks with the predetermined run length with respect to the appearance frequency of the signal component of the spaces with the predetermined run length.

The sync pattern substantially equally includes the marks with the predetermined run length and the spaces with the predetermined run length if the normal recording operation is performed, and the sync pattern can unequally include the marks with the predetermined run length and the spaces with the predetermined run length when it is hardly possible to record the mark or space with the originally intended run length due to the relatively low recording power in the recording of the data pattern. Therefore, according to this aspect, it can be preferably judged whether or not the jitter is effective by reading the sync pattern.

In another aspect of the embodiment of the recording apparatus of the present invention, the recording apparatus further comprises an amplitude limit filtering device for obtaining an amplitude limit signal by limiting an amplitude level of the read signal by a predetermined amplitude limit value and for obtaining an equalization-corrected signal by performing a high-frequency emphasis filtering process on the amplitude limit signal, and the judging device judges whether or not the jitter obtained from the read signal is effective, on the basis of a change amount of the appearance frequency of at least one signal component included in the read signal with respect to the appearance frequency of the at least one signal component included in the equalization-corrected signal.

According to this aspect, the amplitude level of the read signal is limited by the operation of the amplitude limit filtering device. Specifically, in a signal component of the read signal in which the amplitude level is greater than the upper limit of the amplitude limit value or less than the lower limit, the amplitude level is limited to the upper limit or lower limit of the amplitude limit value. On the other hand, in a signal component of the read signal in which the amplitude level is less than or equal to the upper limit of the amplitude limit value and greater than or equal to the lower limit, the amplitude level is not limited. A high-frequency emphasis filtering process is performed on the read signal in which the amplitude level is limited as described above (i.e. the amplitude limit signal). As a result, the equalization-corrected signal is obtained.

This emphasizes the amplitude of the mark or space with the relatively short or shortest run length included in the equalization-corrected signal. As a result, it is possible to bring the appearance frequency of each mark or each space included in the equalization-corrected signal, close to an original appearance frequency. Therefore, it can be preferably judged whether or not the jitter is effective by comparing the appearance frequency of each mark or each space included in the read signal with the appearance frequency of each mark or each space included in the equalization-corrected signal.

In particular, as there is no need to have the reference frequency in advance in a form of table or the like, it is possible to perform the aforementioned operation even on various recording media or unknown recording media. Therefore, it can be preferably judged whether or not the jitter is effective even in the various recording media or unknown recording media.

### Embodiment of Recording Method

A recording method of the present invention is provided with: a detecting process of detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging process of judging whether or not a jitter obtained from the read signal is effective, on the basis of a change amount of the appearance frequency of the at least one signal component.

According to the embodiment of the recording method of the present invention, it is possible to receive the same various effects as those that can be received by the embodiment of the recording apparatus of the present invention described above.

Incidentally, in response to the various aspects in the embodiment of the recording apparatus of the present invention described above, the embodiment of the recording method of the present invention can also adopt various aspects.

### Embodiment of Computer Program

An embodiment of the computer program of the present invention is a computer program for recording control and for controlling a computer provided in a recording apparatus comprising: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging device for judging whether or not a jitter obtained from the read signal is effective, on the basis of a change amount of the appearance frequency of the at least one signal component (i.e. the embodiment of the recording apparatus of the present invention described above (including its various aspects)), the computer program making the computer function as said detecting device and said judging device.

According to the embodiment of the computer program of the present invention, the embodiment of the recording apparatus of the present invention described above can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects in the embodiment of the recording apparatus of the present invention described above, the embodiment of the computer program of the present invention can also adopt various aspects.

An embodiment of the computer program product of the present invention is a computer program product in a computer-readable medium for tangibly embodying a program of instructions executable by a computer provided in a recording apparatus comprising: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; and a judging device for judging whether or not a jitter obtained from the read signal is effective, on the basis of a change amount of the appearance frequency of the at least one signal component (i.e. the embodiment of the recording apparatus of the present invention described above (including its various aspects)), the computer program product making the computer function as said detecting device and said judging device.

According to the embodiment of the computer program product of the present invention, the embodiment of the recording apparatus of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the embodiment of the recording apparatus of the present invention described above.

Incidentally, in response to the various aspects in the embodiment of the recording apparatus of the present invention described above, the embodiment of the computer program product of the present invention can also adopt various aspects.

The operation and other advantages of the embodiment will become more apparent from the example explained below.

As explained above, according to the embodiment of the recording apparatus of the present invention, it is provided with the detecting device and the judging device. According to the embodiment of the recording method of the present invention, it is provided with the detecting process and the judging process. According to the embodiment of the computer program of the present invention, it makes a computer function as the embodiment of the recording apparatus of the present invention. Therefore, it can be preferably judged whether or not the jitter of the data pattern recorded on the recording medium is effective.

### Example

Hereinafter, an example of the present invention will be explained on the basis of the drawings.

### (1) Structure of Recording/Reproducing Apparatus

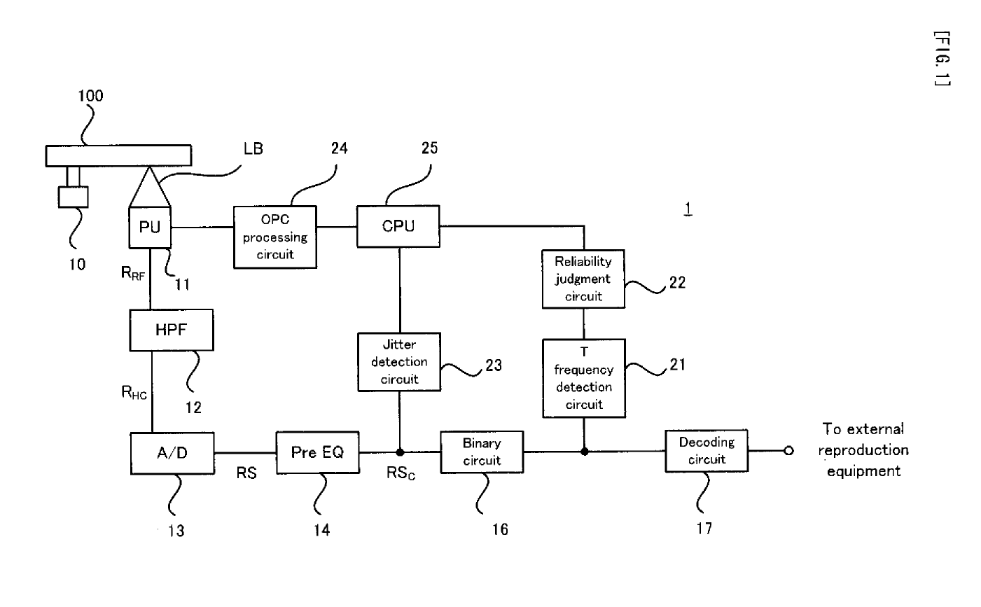

Firstly, with reference to FIG. 1, an example of the recording/reproducing apparatus of the present invention will be explained. FIG. 1 is a block diagram conceptually showing the basic structure of the recording/reproducing apparatus in the example.

As shown in FIG. 1, a recording/reproducing apparatus 1 in the example is provided with a spindle motor 10, a pickup (PU) 11, a high pass filter (HPF) 12, an A/D converter 13, a pre equalizer 14, a binary circuit 16, a decoding circuit 17, a T frequency detection circuit 21, a reliability judgment circuit 22, a jitter detection circuit 23, an optimum power control (OPC) circuit 24, and a central processing unit (CPU) 25.

In the reproduction, the pickup 11 photoelectrically converts reflected light when applying a laser beam LB on the recording surface of an optical disc 100 rotated by the spindle motor 10, and it generates a read signal R_{RF}. Moreover, in the recording, the pickup 11 applies the laser beam LB on the recording surface of the optical disc 100 while modulating the laser beam LB in accordance with a data patter to be recorded, under the control of the CPU 25.

The HPF 12 removes the low-frequency component of the read signal R_{RF} outputted from the pickup, and it outputs a resulting read signal R_{HC} to the A/D converter 13.

The A/D converter 13 samples the read signal R_{HC} in accordance with a sampling clock outputted from a not-illustrated phased lock loop (PLL) or the like, and it outputs a resulting read sample value series RS to the pre equalizer 14.

The pre equalizer 14 removes intersymbol interference based on the transmission characteristics of an information reading system formed of the pickup 11 and the optical disc 100, and it outputs a resulting read sample value series RS_{C} to each of the binary circuit 16 and the jitter circuit 23.

The binary circuit 16 performs a binary process on the read sample value series RS_{c}, and it outputs a resulting binary signal to each of the decoding circuit 17 and the T frequency detection circuit 21.

The decoding circuit 17 performs a decoding process or the like on the binary signal, and it outputs a resulting reproduction signal to an external reproduction equipment, such as a display and a speaker. As a result, the data pattern recorded on the optical disc 100 (e.g. video data, audio data, or the like) is reproduced.

The T frequency detection circuit 21 constitutes one specific example of the “detecting device” of the present invention and detects the appearance frequency of each of a mark and a space included in the binary signal in each run length. For example, if the optical disc 100 is a DVD, the T frequency detection circuit 21 detects the appearance frequency of each of marks with run lengths of 3T to 11T and 14T and spaces with run lengths of 3T to 11T and 14T. Alternatively, for example, if the optical disc 100 is a Blu-ray Disc, the T frequency detection circuit 21 detects the appearance frequency of each of marks with run lengths of 2T to 9T and spaces with run lengths of 2T to 9T.

The reliability judgment circuit 22 constitutes one specific example of the “judging device” of the present invention and judges whether or not a jitter detected on the jitter detection circuit 23 has a reliable value (in other words, an effective value) on the basis of the appearance frequency of each mark and each space detected by the T frequency detection circuit 21.

The jitter detection circuit 23 detects the jitter from the read sample value series RS_{c}. The detected jitter is outputted to the CPU 25.

The OPC processing circuit 24 constitutes one specific example of the “recording device” of the present invention and controls the pickup 11 to record an OPC pattern onto the optical disc 100 while changing the recording power in order to calculate the optimum recording power of the laser beam LB in the recording.

The CPU 25 controls the entire operation of the recording/reproducing apparatus 1. Moreover, the CPU 25 constitutes one specific example of the “calculating device” of the present invention and calculates the optimum recording power of the laser beam LB in the recording, on the basis of the jitter outputted from the jitter detection circuit 23 and the judgment result of the reliability judgment circuit 22 by reproducing the OPC pattern recorded by the OPC processing circuit 24.

### (2) Operation of Reproducing Apparatus

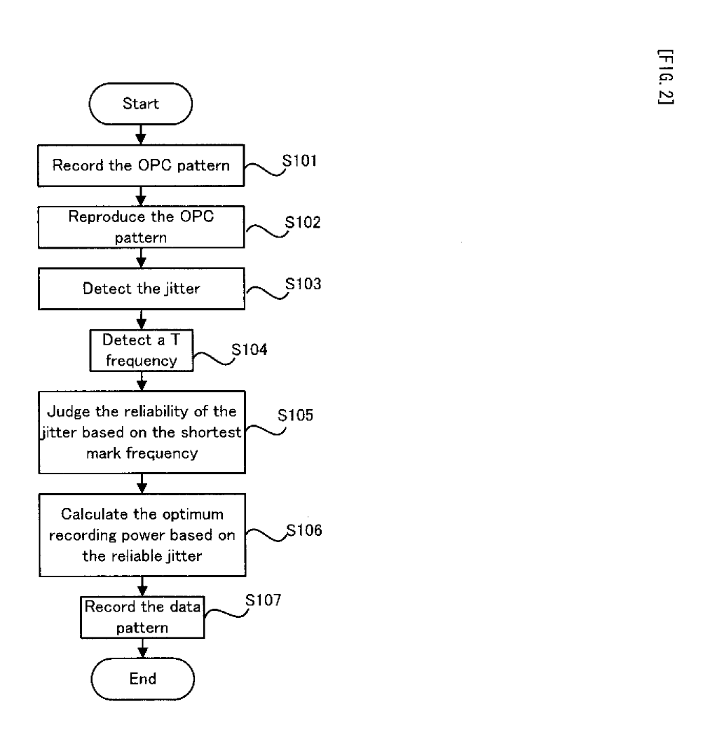

Next, with reference to FIG. 2, the operations of the recording/reproducing apparatus 1 in the example will be explained. FIG. 2 is a flowchart conceptually showing a flow of operations of the recording/reproducing apparatus 1 in the example.

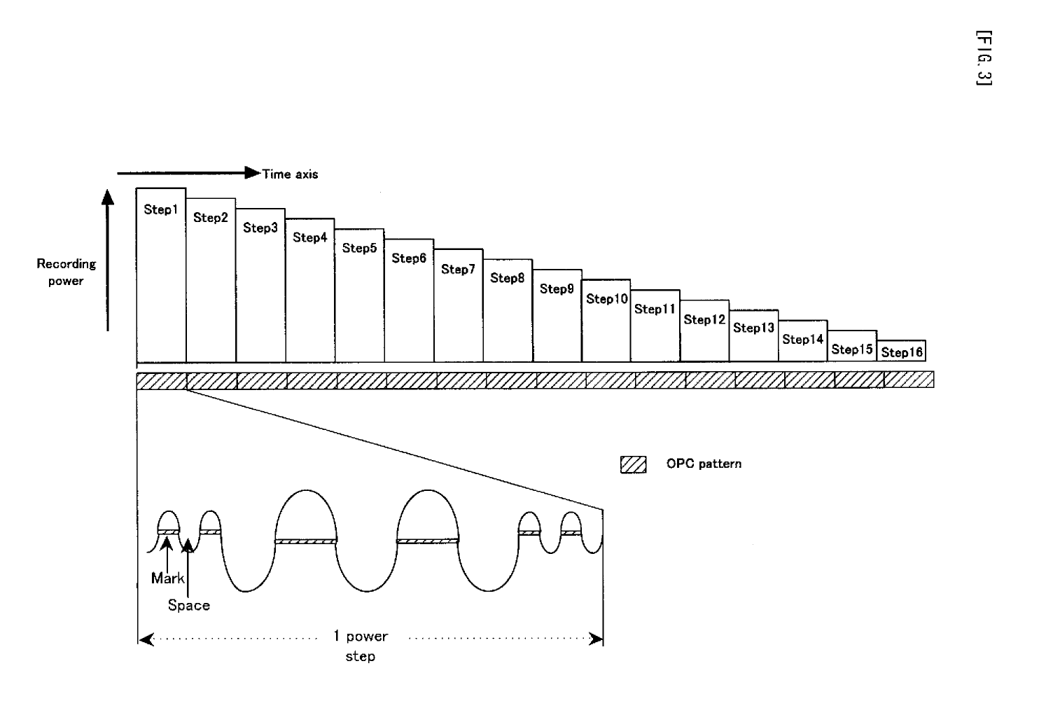

As shown in FIG. 2, by the operation of the OPC processing circuit 24, the OPC pattern is recorded onto the optical disc 100 (step S101). Now, a detailed explanation will be given on the recording of the OPC pattern with reference to FIG. 3.

Firstly, under the control by the OPC processing circuit 24, the pickup 11 is displaced to a power control area (PCA) on the optical disc 100. Then, the recording power of the laser beam LB is changed sequentially and gradually (e.g. in FIG. 3, in 16 states), and the OPC pattern is recorded into the PCA. As the OPC pattern, for example, a random pattern formed by the combination of the marks and spaces with run lengths of 3T to 11T and 14T (if the optical disc 100 is a DVD) or a random pattern formed by the combination of the marks and spaces with run lengths of 2T to 9T (if the optical disc 100 is a Blu-ray Disc) is listed as one example. FIG. 3 shows an aspect in which a common OPC pattern is recorded with each recording power changed gradually, as one specific example. Of course, different OPC patterns may be used with each recording power changed gradually.

In FIG. 2 again, then, the OPC pattern recorded in the step S101 is reproduced (step S102). In other words, the read signal R_{RF} is generated by the pickup 11, the read signal R_{HC} is generated from the read signal R_{RF} by the HPF 12, the read sample value series RS is generated from the read signal R_{HC} by the A/D converter 13, the read sample value series RS_{C} from the read sample value series RS by the pre equalizer 14, and the binary signal is generated from the read sample value series RS_{C} by the binary circuit 16.

Then, by the operation of the jitter circuit 23, the jitter of the OPC pattern recorded in the step S101 is detected (step S103). Such detection of the jitter is performed in accordance with the number of OPC patterns recorded in one OPC process, with each recording power changed gradually. As a result, the jitter of the OPC pattern is detected with each recording power changed gradually. The detected jitter is outputted to the CPU 25. This allows the CPU 25 to recognize a correlation between the jitter and the recording power.

Following or in parallel with the process in the step S103, the appearance frequency (or T frequency) of the mark and the space included in the binary signal obtained by reproducing the OPC pattern is detected by the operation of the T frequency detection circuit 21 (step S104). Such detection of the appearance frequency is performed in accordance with the number of the OPC patterns recorded in one OPC process with each recording power changed gradually. As a result, the appearance frequency is detected with each recording power changed gradually. The detected appearance frequency is outputted to the reliability judgment circuit 22. This allows the reliability judgment circuit 22 to recognize a correlation between the appearance frequency and the recording power.

Then, by the operation of the reliability judgment circuit 22, the jitter corresponding to the recording power in which the appearance frequency of the mark with the shortest run length (hereinafter referred to as the “shortest mark” as occasion demands) detected in the step S104 is less than a reference frequency (referenced appearance frequency) at a predetermined ratio or more, is judged as an unreliable jitter on the basis of the correlation between the appearance frequency and the recording power (step S105). In other words, the jitter corresponding to the recording power in which the appearance frequency of the shortest mark is not less than the reference frequency at the predetermined ratio or more, is judged as a reliable jitter. That is, if the optical disc 100 is a DVD, the jitter corresponding to the recording power in which the appearance frequency of the mark with a run length of 3T is less than the reference frequency of the mark with a run length of 3T at the predetermined ratio or more, is set as the unreliable jitter. On the other hand, the jitter corresponding to the recording power in which the appearance frequency of the mark with a run length of 3T is not less than the reference frequency of the mark with a run length of 3T at the predetermined ratio or more, is set as the reliable jitter. In the same manner, if the optical disc 100 is a Blu-ray Disc, the jitter corresponding to the recording power in which the appearance frequency of the mark with a run length of 2T is less than the reference frequency of the mark with a run length of 2T at the predetermined ratio or more, is set as the unreliable jitter. On the other hand, the jitter corresponding to the recording power in which the appearance frequency of the mark with a run length of 2T is not less than the reference frequency of the mark with a run length of 2T at the predetermined ratio or more, is set as the reliable jitter. The reliability of the jitter judged here is outputted to the CPU 25. As a result, the CPU 25 can recognize whether or not the jitter with which recording power is reliable.

Here, the reference frequency is preferably the appearance frequency of each mark and each space in a case where a predetermined data pattern or random data pattern is recorded onto the optical disc 100 with a relatively high recording power. The reference frequency may be stored in advance in a memory or the like provided for the recording/reproducing apparatus 1, may be recorded on the optical disc 100, or may be generated by the recording/reproducing apparatus 1 as occasion demands. Therefore, the reliability judgment circuit 22 preferably performs the judgment operation in the step S105 by reading the reference frequency stored in advance or recorded in advance.

Moreover, as the predetermined ratio, a proper value is preferably determined in advance on an experimental, experiential, or simulation basis, in view of an influence of a change in the recording power on the recording of the shortest mark (or mark with a relatively short run length), an influence of the change in the recording power on the jitter, or the like. For example, the ratio of the appearance frequency of each mark and each space to the reference frequency in a case where the recording power is relatively low enough not to preferably record the shortest mark is listed as one example of the predetermined ratio. More specifically, for example, “50% (or several tens % to hundred and several tens %)” is listed as one example of the predetermined ratio. However, the predetermined ratio is not limited to this example.

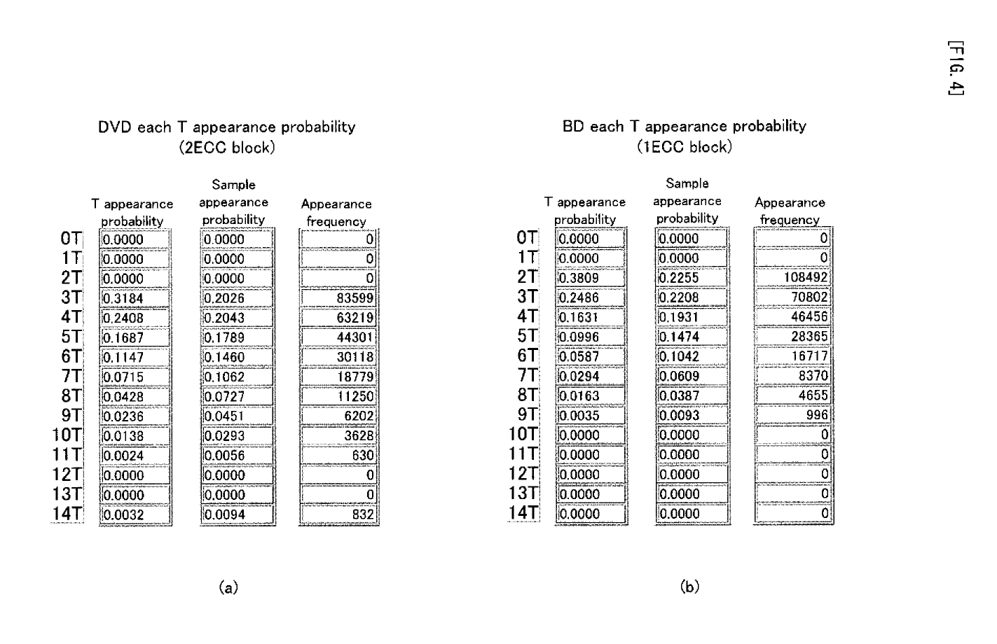

Now, with reference to FIG. 4, the reference frequency of each mark and each space will be explained. FIG. 4 are tables showing the reference frequency of each mark and each space. Incidentally, in FIG. 4, an explanation will be given on a DVD in which the data pattern is recorded by using the marks and spaces with run lengths of 3T to 11T and 14T and a Blu-ray Disc in which the data pattern is recorded by using the marks and spaces with run lengths of 2T to 9T, as one specific example of the optical disc 100. Moreover, a mark with a certain run length makes a pair with a space with the same run length and is recorded on the optical disc 100, so the appearance frequency of each of the mark and the space is shown as a common value in FIG. 4.

FIG. 4(a) shows the reference frequency without the run length considered (i.e. T appearance probability) of the mark or space with each run length in 2ECC blocks in a case where the random data pattern is recorded onto the DVD as one specific example of the optical disc 100. As shown in FIG. 4(a), the reference frequency of the mark or space with a run length 3T is about 32%, the reference frequency of the mark or space with a run length 4T is about 24%, the reference frequency of the mark or space with a run length 5T is about 17%, the reference frequency of the mark or space with a run length 6T is about 11.5%, the reference frequency of the mark or space with a run length 7T is about 7%, the reference frequency of the mark or space with a run length 8T is about 4%, the reference frequency of the mark or space with a run length 9T is about 2%, the reference frequency of the mark or space with a run length 10T is about 1.3%, the reference frequency of the mark or space with a run length 11T is about 0.24%, and the reference frequency of the mark or space with a run length 14T is about 0.3%.

Moreover, FIG. 4(a) shows the reference frequency with the run length considered (i.e. sample appearance probability) or the mark or space with each run length in 2ECC block in the case where the random data pattern is recorded onto the DVD as one specific example of the optical disc 100. As shown in FIG. 4(a), the reference frequency of the mark or space with a run length of 3T is about 20%, the reference frequency of the mark or space with a run length 4T is about 20%, the reference frequency of the mark or space with a run length 5T is about 18%, the reference frequency of the mark or space with a run length 6T is about 15%, the reference frequency of the mark or space with a run length 7T is about 11%, the reference frequency of the mark or space with a run length 8T is about 7.3%, the reference frequency of the mark or space with a run length 9T is about 4.5%, the reference frequency of the mark or space with a run length 10T is about 2.9%, the reference frequency of the mark or space with a run length 11T is about 0.56%, and the reference frequency of the mark or space with a run length 14T is about 0.94%.

FIG. 4(b) shows the reference frequency without the run length considered (i.e. T appearance probability) of the mark or space with each run length in 1ECC block in a case where the random data pattern is recorded onto the Blu-ray Disc as one specific example of the optical disc 100. As shown in FIG. 4(b), the reference frequency of the mark or space with a run length 2T is about 38%, the reference frequency of the mark or space with a run length 3T is about 25%, the reference frequency of the mark or space with a run length 4T is about 16%, the reference frequency of the mark or space with a run length 5T is about 10%, the reference frequency of the mark or space with a run length 6T is about 6%, the reference frequency of the mark or space with a run length 7T is about 3%, the reference frequency of the mark or space with a run length 8T is about 1.6%, and the reference frequency of the mark or space with a run length 9T is about 0.35%.

FIG. 4(b) shows the reference frequency with the run length considered (i.e. sample appearance probability) of the mark or space with each run length in 1ECC block in the case where the random data pattern is recorded onto the Blu-ray Disc as one specific example of the optical disc 100. As shown in FIG. 4(b), the reference frequency of the mark or space with a run length 2T is about 23%, the reference frequency of the mark or space with a run length 3T is about 22%, the reference frequency of the mark or space with a run length 4T is about 19%, the reference frequency of the mark or space with a run length 5T is about 15%, the reference frequency of the mark or space with a run length 6T is about 10%, the reference frequency of the mark or space with a run length 7T is about 6%, the reference frequency of the mark or space with a run length 8T is about 3.9%, and the reference frequency of the mark or space with a run length 9T is about 0.93%.

Incidentally, the reference frequency without the run length considered is the reference frequency in which weighting in calculating the reference frequency of the mark or space with each run length is the same in each run length. In other words, it indicates the reference frequency in a case where the number of appearance is counted as one time when one mark or space with a certain run length appears. On the other hand, the reference frequency with the run length considered is the reference frequency in which weighting in calculating the reference frequency of the mark or space with each run length depends on the run length. In other words, it indicates the reference frequency in a case where the number of appearance is counted by the number of times according to the run length when one mark or space with a certain run length appears. Considering that there are two types of reference frequencies as described above, the T frequency detection circuit 21 preferably detects one or both of the two types of appearance frequencies (i.e. the appearance frequency without the run length considered and the appearance frequency with the run length considered). Moreover, the reliability judgment circuit 22 preferably judges the jitter corresponding to the recording power in which the appearance frequency without the run length considered is less than the reference frequency without the run length considered by the predetermined portion or more, as the unreliable jitter. In the same manner, the reliability judgment circuit 22 preferably judges the jitter corresponding to the recording power in which the appearance frequency with the run length considered is less than the reference frequency with the run length considered by the predetermined portion or more, as the unreliable jitter.

In FIG. 2 again, then, by the operation of the CPU 25, the optimum recording power of the laser beam LB is calculated on the basis of the correlation between the jitter and the recording power outputted from the jitter circuit 23 (step S106). Here, in particular, the optimum recording power of the laser beam LB is calculated by selectively using the jitter that is judged to be reliable in the step S105 (in other words, without selectively using the jitter that is judged to be unreliable in the step S105).

Then, the laser beam LB with the optimum recording power is applied from the pickup 11, by which the data pattern is recorded onto the optical disc 100 (step S107).

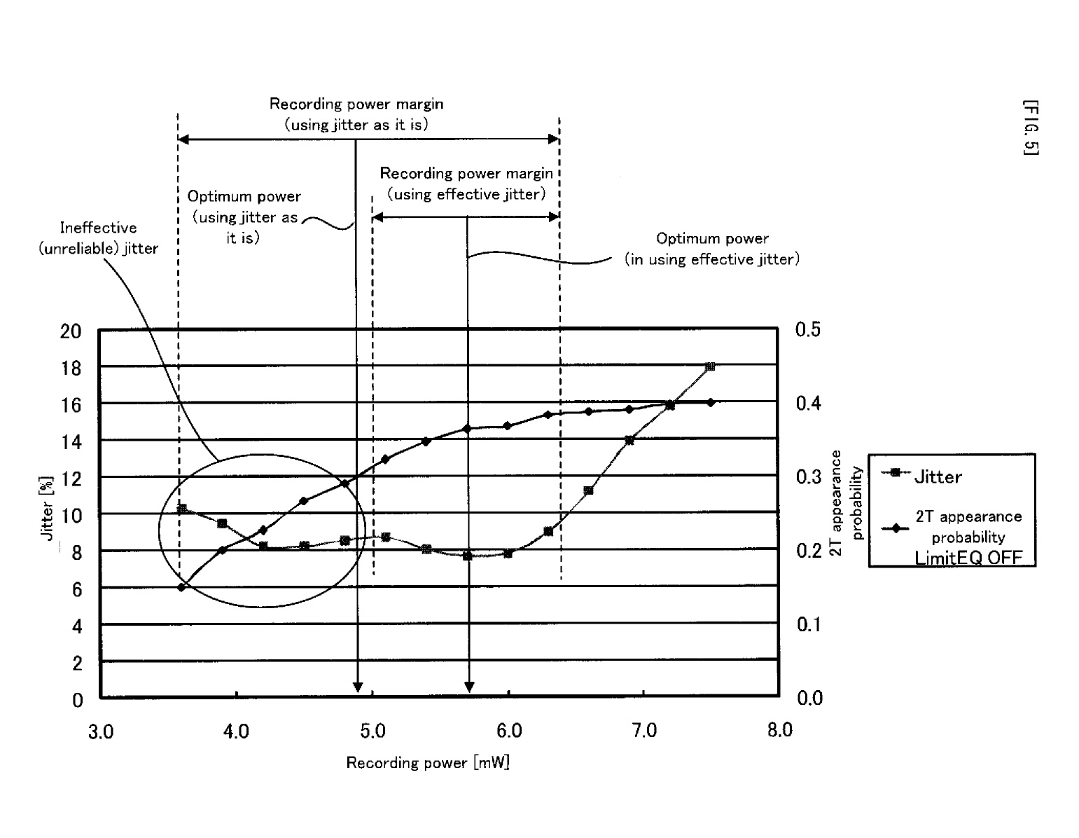

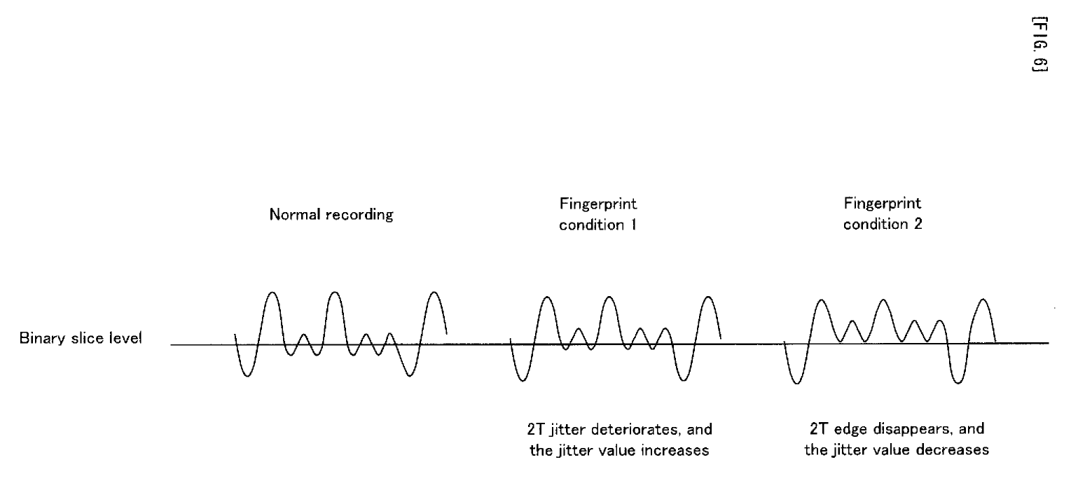

Next, the operation of calculating the optimum recording power of the laser beam LB in the step S106 in FIG. 2 will be explained in more detail with reference to FIG. 5 and FIG. 6. FIG. 5 is a graph showing a correlation between the recording power and each of the jitter and the appearance frequency of the shortest mark. FIG. 6 is a graph showing the conditions of the read signal R_{RF} obtained by reproducing the data pattern recorded with various recording powers, with a binary slice level. Incidentally, FIG. 5 explains an example in which a Blu-ray Disc is used as the optical disc 100.

As shown in FIG. 5, in a range that the recording power is less than or equal to a predetermined value (in the example shown in FIG. 5, for example, about 6.0 mW), as the recording power is reduced, the appearance frequency of the shortest mark (i.e. the mark with a run length of 2T) is reduced. On the other hand, it can be said that the reduction in the appearance frequency of the shortest mark indicates that the OPC pattern cannot be preferably recorded. Thus, under normal circumstances, the jitter is supposed to monotonically increase (i.e. deteriorate) with the reduction in the appearance frequency of the shortest mark. However, as shown in FIG. 5, the jitter does not monotonically increase with the reduction in the appearance frequency of the shortest mark, and there arises a portion in which the jitter is improved in the middle. This reason will be explained by using FIG. 6.

As shown on the left side of FIG. 6, if the OPC pattern is recorded with a relatively high recording power (e.g. a recording power of 5.8 mW or more in FIG. 5), the shortest mark can be preferably recorded. Therefore, a signal waveform corresponding to each mark and each space included in the read signal R_{RF} preferably crosses the binary slice level. Therefore, the appearance frequency of the read signal R_{RF} in this condition does not greatly change.

Then, as shown in the center of FIG. 6, if the OPC pattern is recorded with a lower recording power than the recording power in the recording on the left side of FIG. 6 (e.g. a recording power of 5.0 mW to 5.8 mW in FIG. 5), an energy necessary to record the mark with an originally intended run length cannot be sufficiently given to the recording surface of the optical disc 100. This is remarkable particularly in the recording of the mark with a short run length. Thus, for example, the mark which is supposed to be recorded as the mark with a run length of 2T is likely recorded as the mark with a run length of 1T. That is, a relatively short mark is recorded. Therefore, as shown in the area near 5.0 mW to 5.8 mW in FIG. 5, the appearance frequency of the shortest mark is reduced. In addition, in this case, in the read signal R_{RF}, particularly, such a signal component is obtained that a signal component corresponding to the shortest mark is shifted to a signal component corresponding to the space (i.e. on the upper side in FIG. 6). In this case, the jitter with the signal component corresponding to the shortest mark deteriorates. As a result, as shown in the area near 5.0 mW to 5.8 mW in FIG. 5, the jitter as the entire read signal R_{RF} (i.e. total jitter) deteriorates.

On the other hand, as shown on the right side of FIG. 6, if the OPC pattern is recorded with a lower recording power than the recording power in the recording in the center of FIG. 6 (e.g. a recording power of 5.0 mW or less in FIG. 5), for example, the mark which is supposed to be recorded as the mark with a run length of 2T is more likely recorded as the mark with a run length of 1T. Therefore, as shown in the area near 5.0 mW or less in FIG. 5, the appearance frequency of the shortest mark is reduced. In addition, in this case, in the read signal R_{RF}, such a signal component is obtained in some cases that the signal component corresponding to the shortest mark is shifted to the signal component corresponding to the space until the signal component corresponding to the shortest mark does not cross the binary slice level. In this case, the jitter with the signal component corresponding to the shortest mark does not contribute to the calculation of the jitter as the entire read signal R_{RF}. Therefore, as shown in the area of 5.0 mW or less in FIG. 5, the jitter as the entire read signal R_{RF} does not monotonically deteriorate. In other words, in a part of range (e.g. a recording power range of 4.5 mW to 5.0 mW in FIG. 5), the jitter obtained in the reproduction is likely improved.

In the configuration that the optimum recording power is calculated by using the jitter obtained by reproducing the OPC pattern as it is (in other words, without considering the appearance frequency of each mark and each space), the recording power different from the original optimum recording power is likely calculated as the optimum recording power. Specifically, normally, the range of the recording power in which the jitter has an allowable value (e.g. 10% or less) is set to be a power margin, and the center value of the power margin is set to be the optimum power. Thus, in the configuration that the optimum recording power is calculated by using the jitter obtained by reproducing the OPC pattern as it is, 3.5 mW to 6.4 mW is set as the power margin. Thus, 4.9 mW is calculated as the optimum recording power. However, as described above, the power likely does not allow the preferable recording of the shortest mark, so it is not always to be the optimum recording power.

However, in the example, the optimum recording power is calculated without using the unreliable (i.e. ineffective) jitter. Specifically, the recording power in which the jitter is reliable (i.e. effective) and the jitter is in an allowable range (e.g. 10% or less) is set as the power margin, and the center value of the power margin is calculated as the optimum recording power. Therefore, in the example, 5.1 mW to 6.5 mW is set as the power margin. Thus, 5.8 mW is set as the optimum recording power.

As described above, according to the recording/reproducing apparatus 1 in the example, the reliability (or effectiveness) of the jitter is judged on the basis of the appearance frequency of each mark and each space, and the optimum recording power is calculated by using the reliable jitter (in other words, without using the unreliable jitter). Thus, the optimum recording power can be calculated more preferably.

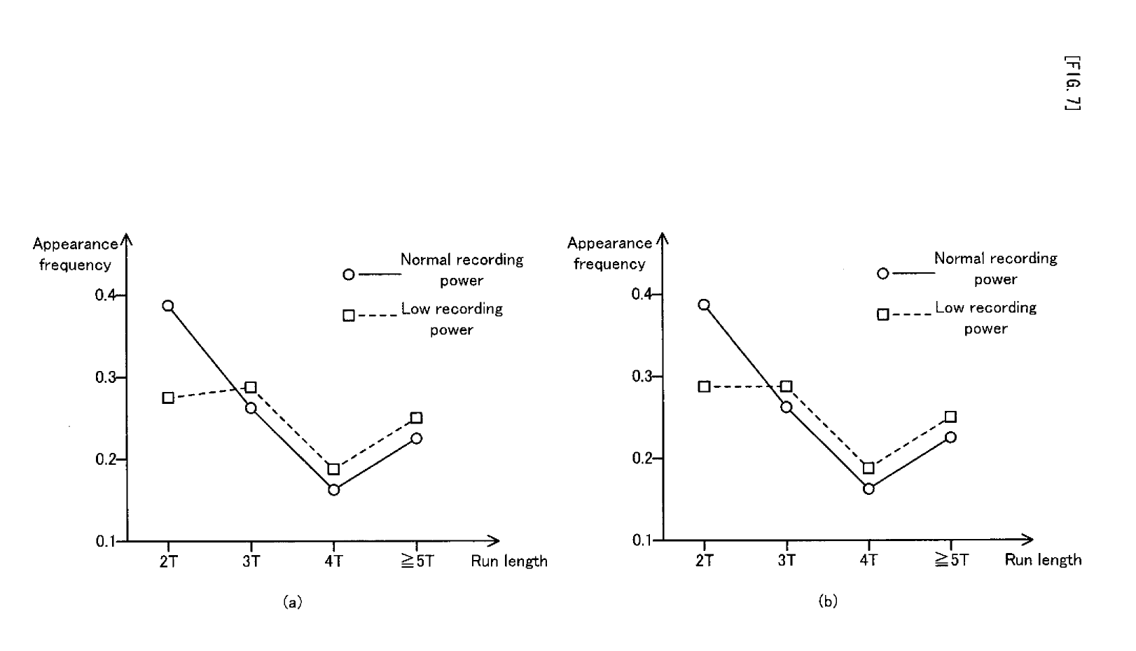

Incidentally, the aforementioned explanation states the example in which the reliability of the jitter is judged on the basis of the appearance frequency of the shortest mark. However, as shown in FIG. 7(a) and FIG. 7(b), not only the appearance frequency of the shortest mark but also the appearance frequencies of the space with the shortest run length and the mark or space with another run length also can change depending on the recording power. Here, FIG. 7(a) is a view showing the appearance frequency of each of the marks recorded with a normal recording power and a relatively low recording power, and FIG. 7(b) is a view showing the appearance frequency of each of the spaces recorded with the normal recording power and the relatively low recording power. Therefore, the reliability of the jitter may be also judged on the basis of the appearance frequencies of the space with the shortest run length and the mark or space with another run length. For example, the appearance frequency of the space with the shortest run length recorded with the relatively low recording power can be less than the appearance frequency (i.e. reference frequency) of the space with the shortest run length recorded with the normal recording power (i.e. relatively high recording power). Therefore, if the appearance frequency of the space with the shortest run length is less than the reference frequency at a predetermined ratio, it may be judged that the jitter is not reliable. Moreover, the appearance frequency of the mark or space other than the mark or space with the shortest run length recorded with the relatively low recording power can be greater than the appearance frequency of the mark or space other than the mark or space with the shortest run length recorded with the normal recording power (i.e. reference frequency). Therefore, if the appearance frequency of the mark or space other than the mark or space with the shortest run length is greater than the reference frequency at a predetermined ratio, it may be judged that the jitter is not reliable.

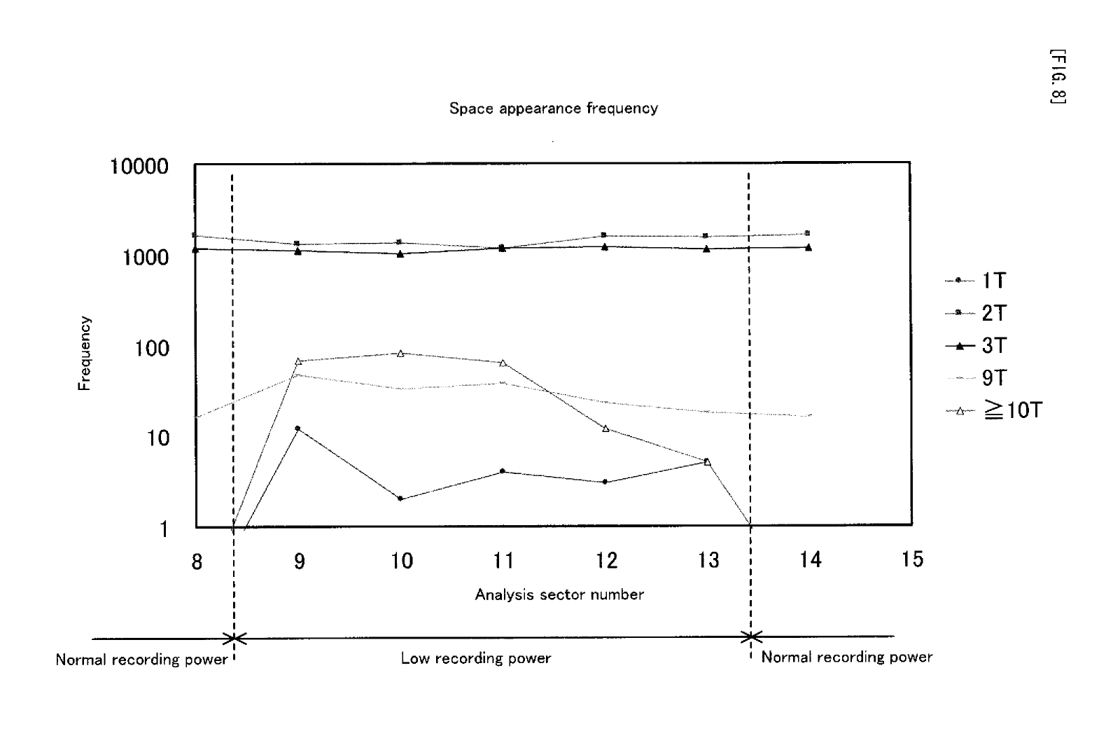

In particular, if the data pattern is recorded with the relatively low recording power, the change in the appearance frequency of the space with the relatively long or longest run length becomes the greatest due to the reduction in the appearance frequency of the space with the shortest run length. Therefore, the reliability of the jitter is preferably judged on the basis of the appearance frequency of the space with the relatively long or longest run length. Now, with reference to FIG. 8, an explanation will be given on the appearance frequency of the space with the relatively long or longest run length. FIG. 8 is a graph showing the appearance frequency of the space recorded with each of the normal recording power and the relatively low recording power. Incidentally, FIG. 8 explains the example in which a Blu-ray Disc is used as the optical disc 100.

As shown in FIG. 8, the appearance frequency of the space with the longest run length (i.e. the space with a run length of 9T) recorded with the relatively low recording power can be greater than the appearance frequency of the space with the longest run length recorded with the normal recording power. This happens for the following reasons. For example, because the mark which is supposed to be recorded as the mark with a run length of 2T is recorded as the mark with a run length of 1T, the mark with a run length of 1T which does not cross the zero level is connected to the spaces before and after the mark, thereby likely appearing as the space with a run length of 9T in the reproduction.

Therefore, if the appearance frequency of the space with the longest run length is greater than the reference frequency at a predetermined ratio, it may be judged that the jitter is not reliable. As described above, the reliability of the jitter is judged on the basis of the space with the longest run length in which the appearance frequency changes depending on the appearance frequency of the mark with the shortest run length, so the reliability of the jitter can be judged highly accurately or easily.

Incidentally, as shown in FIG. 8, if the data pattern is recorded with the relatively low recording power, the space with the run length (specifically, 1T or 10T or more) other than the run length determined by a standard (specifically, 2T to 9T) increases. For example, the space with a run length of 10T or more can appear by the space being connected to another space because the mark with a run length of 2T is recorded as the mark with a run length of 1T. Therefore, the reliability of the jitter may be judged on the basis of the appearance frequency of the space with the run length other than the run length determined by the standard. In this case, if the appearance frequency of the space with the run length other than the run length determined by the standard is greater than or equal to a predetermined amount, it may be judged that the jitter is not reliable.

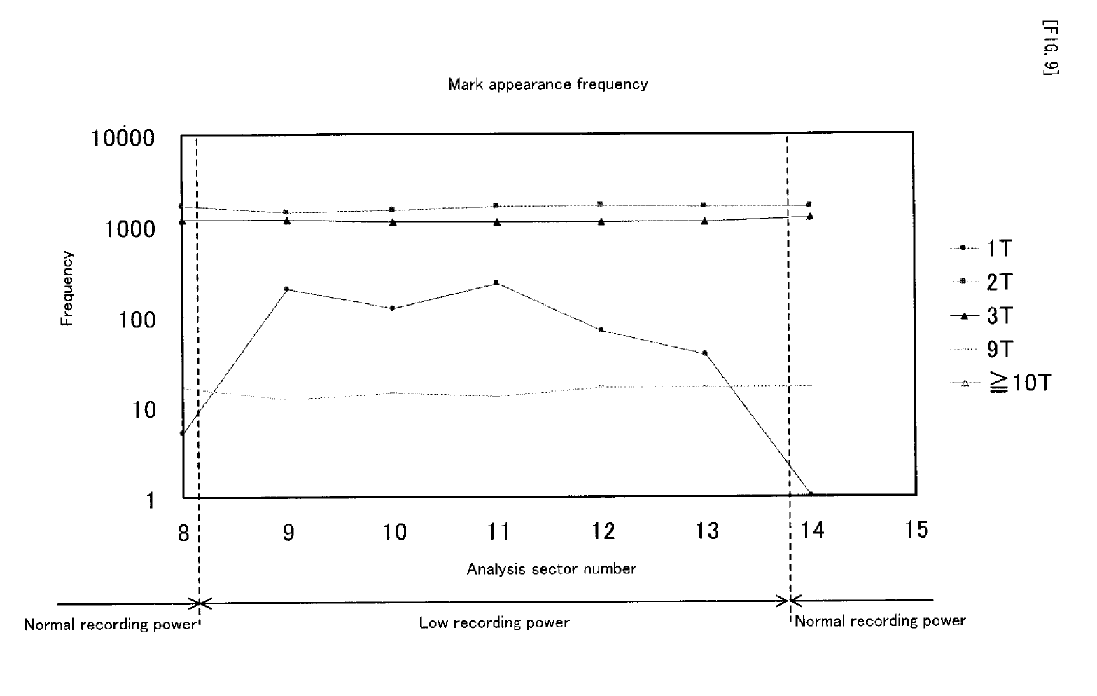

Moreover, the same holds true not only for the appearance frequency of the space with the run length other than the run length determined by the standard but also for the appearance frequency of the mark with the run length other than the run length determined by the standard. Now, with reference to FIG. 9, an explanation will be given on the appearance frequency of the mark with the run length other than the run length determined by the standard. FIG. 9 is a graph showing the appearance frequency of the mark recorded with each of the normal recording power and the relatively low recording power. Incidentally, FIG. 9 explains the example in which a Blu-ray Disc is used as the optical disc 100.

As shown in FIG. 9, if the data pattern is recorded with the relatively low recording power, the mark with the run length (specifically, 1T) other than the run length determined by the standard (specifically, 2T to 9T) increases. Therefore, the reliability of the jitter may be judged on the basis of the appearance frequency of the mark with the run length other than the run length determined by the standard. In this case, if the appearance frequency of the mark with the run length other than the run length determined by the standard is greater than or equal to a predetermined amount, it may be judged that the jitter is not reliable.

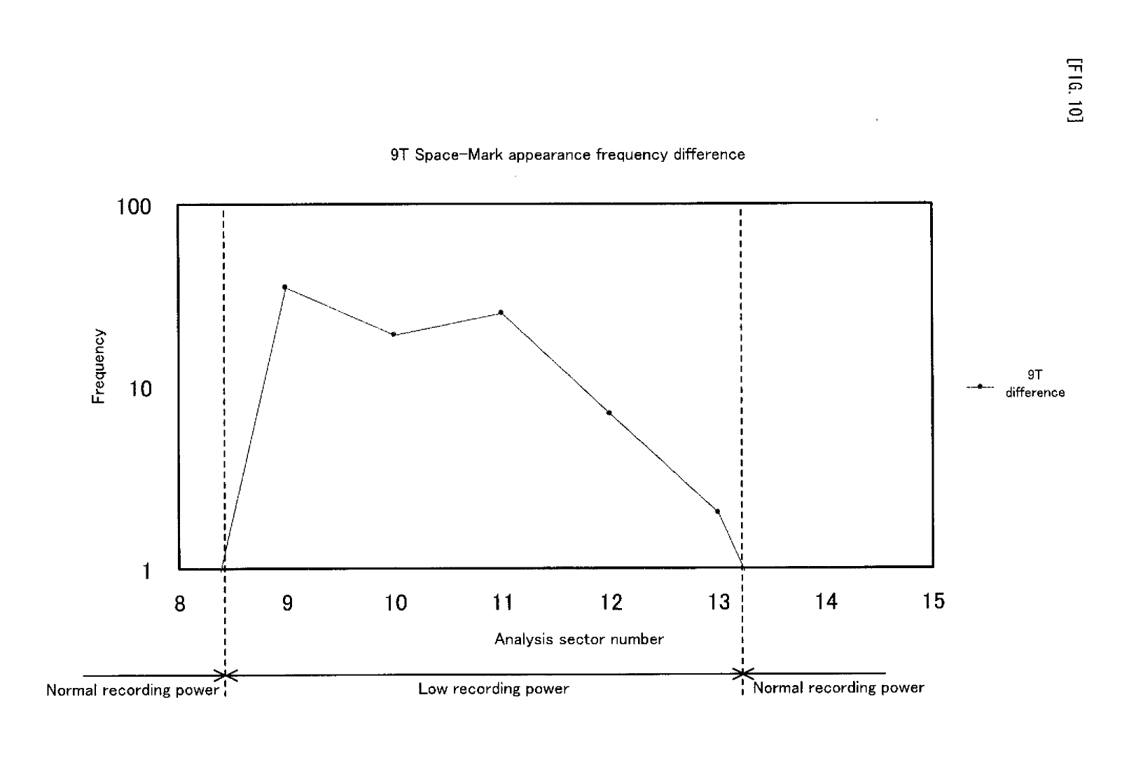

Moreover, in the Blu-ray Disc as one specific example of the optical disc 100, as a sync pattern (synchronization pattern), the data pattern alternately including the marks with a run length of 9T and the spaces with a run length of 9T is adopted. The reliability of the jitter may be judged on the basis of the appearance frequency of each of the mark with a run length of 9T and the space with a run length of 9T in the sync pattern. This example will be explained with reference to FIG. 10. FIG. 10 is a graph showing a difference in the appearance frequency between the space with a run length of 9T and the space with a run length of 9T in the sync pattern.

As shown in FIG. 10, if the data pattern is recorded with the normal recording power, the appearance frequencies of the mark with a run length of 9T and the space with a run length of 9T in the sync pattern are substantially the same. In other words, a frequency difference (=the appearance frequency of the mark with a run length of 9T−the appearance frequency of the space with a run length of 9T) is approximately 0. On the other hand, if the data pattern is recorded with the relatively low recording power, the appearance frequencies of the mark with a run length of 9T and the space with a run length of 9T in the sync pattern are different from each other. Specifically, for example, because the mark with a run length of 2T is recorded as the mark with a run length of 1T, if the space with a run length of 1T is connected to another space, the appearance frequency of the space with a run length of 9T can increase with respect to the appearance frequency of the mark with a run length of 9T. Moreover, for example, because the mark with a run length of 2T is recorded as the mark with a run length of 1T, if the space with a run length of 9T is connected to another space, the appearance frequency of the space with a run length of 9T can decrease with respect to the appearance frequency of the mark with a run length of 9T.

As described above, if there is the difference between the appearance frequencies of the mark with a run length of 9T and the space with a run length of 9T in the sync pattern, it may be judged that the jitter is not reliable. In other words, if the frequency difference (=the appearance frequency of the mark with a run length of 9T−the appearance frequency of the space with a run length of 9T) is not 0 (more preferably, significantly deviates from 0), it may be judged that the jitter is not reliable. This makes it possible to preferably judge the reliability of the jitter.

### (3) Modified Example

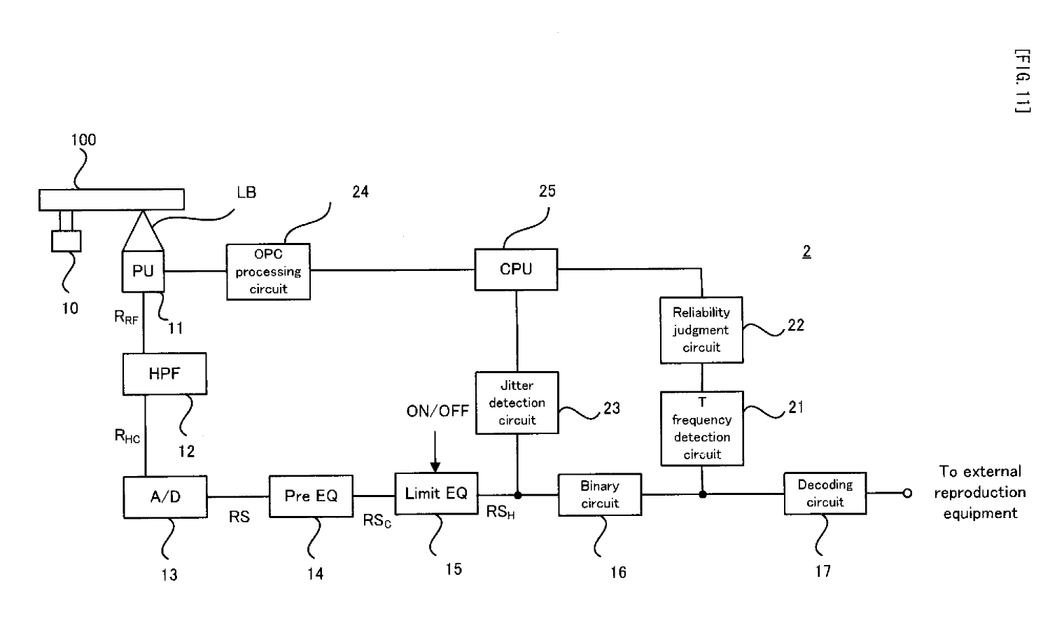

Next, with reference to FIG. 11, a modified example of the recording/reproducing apparatus 1 in the example will be explained. FIG. 11 is a block diagram conceptually showing the structure of a recording/reproducing apparatus 2 in the modified example. Incidentally, the same constituents as those of the recording/reproducing apparatus 1 will carry the same reference numerals, and the detailed explanation thereof will be omitted.

As shown in FIG. 11, the recording/reproducing apparatus 2 in the modified example is provided, as in the aforementioned recording/reproducing apparatus 1, with a spindle motor 10, a pickup (PU) 11, a high pass filter (HPF) 12, an A/D converter 13, a pre equalizer 14, a binary circuit 16, a decoding circuit 17, a T frequency detection circuit 21, a reliability judgment circuit 22, a jitter detection circuit 23, an optimum power control (OPC) circuit 24, and a central processing unit (CPU) 25.

The recording/reproducing apparatus 2 in the modified example is particularly provided with a limit equalizer 15 between the pre equalizer 14 and the binary circuit 16. The limit equalizer 15 constitutes one specific example of the “amplitude limit filtering device” of the present invention. The limit equalizer 15 performs a high-frequency emphasis process on the read sample value series RS_{C} without increasing the intersymbol interference, and it outputs a resulting high-frequency emphasis read sample value series RS_{H} to each of the binary circuit 16 and the jitter detection circuit 23. Incidentally, the operations of the limit equalizer 15 are the same as those of a conventional limit equalizer. Please refer to U.S. Pat. No. 3,459,563 for the details.

In particular, the limit equalizer 15 can be arbitrarily switched on and off. When the limit equalizer 15 is on, the high-frequency emphasis read sample value series RS_{H} is outputted to each of the binary circuit 16 and the jitter detection circuit 23. On the other hand, when the limit equalizer 15 is off, the read sample value series RS_{C}, which is the output of the pre equalizer 14, is outputted to each of the binary circuit 16 and the jitter detection circuit 23.

Moreover, in the modified example, the T frequency detection circuit 21 detects each of the appearance frequency when the limit equalizer 15 is on and the appearance frequency when the limit equalizer 15 is off.

Here, if the limit equalizer 15 is on, the following processes are performed. Firstly, the amplitude level of the read signal R_{RF} is limited by a predetermined amplitude limit value. Specifically, in a signal component of the read signal R_{RF} in which the amplitude level is greater than the upper limit of the amplitude limit value or less than the lower limit, the amplitude level is limited to the upper limit or lower limit of the amplitude limit value. On the other hand, in a signal component of the read signal R_{RF} in which the amplitude level is less than or equal to the upper limit of the amplitude limit value and greater than or equal to the lower limit, the amplitude level is not limited. By performing the amplitude limit process in this manner, an amplitude limit signal R_{LIM} is generated. Then, a high-frequency emphasis filtering process is performed on the amplitude limit signal R_{LIM}. The high-frequency emphasis filtering process herein is a process of increasing the signal level near the signal component corresponding to the mark or space with the shortest run length in the amplitude limit signal R_{LIM}. As a result, the high-frequency emphasis read sample value series RS_{H} is generated.

As described above, due to the emphasized signal component of the mark or space with the shortest run length, even if the data pattern is recorded in the condition that the signal component corresponding to the mark with the shortest run length does not cross the binary slice level (refer to the view on the right in FIG. 6) because the recording power is relatively low, the data pattern can be reproduced such that the signal component crosses the binary slice level (refer to the view on the left side in FIG. 6). In other words, the signal component of the mark or space with the shortest run length recorded with the normal recording power can be outputted from the limit equalizer 15.

Therefore, in the modified example, the reliability judgment circuit 22 uses the appearance frequency detected in the condition that the limit equalizer 15 is on, as the aforementioned reference frequency. In other words, the reliability judgment circuit 22 judges the reliability of the jitter by judging whether or not the appearance frequency detected in the condition that the limit equalizer 15 is off is greater than, less than, at a predetermined ratio greater than, or at a predetermined ratio less than the appearance frequency detected in the condition that the limit equalizer 15 is on.

This allows even the recording/reproducing apparatus 2 in the modified example to preferably receive the various effects that the aforementioned recording/reproducing apparatus 1 can receive. In addition, there is no need to pre-store a table or the like indicating the reference frequency described above, and thus the operation of judging the reliability of the jitter based on the appearance frequency described above can be performed even on the optical disc 100 in which the reference frequency is not set or an unknown optical disc 100.

The present invention is not limited to the aforementioned example, but various changes may be made, if desired, without departing from the essence or spirit of the invention which can be read from the claims and the entire specification. A recording apparatus and method, and a computer program, all of which involve such changes, are also intended to be within the technical scope of the present invention.

1-15. (canceled)

16. A recording apparatus comprising:
a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths;
a judging device for judging whether or not a jitter obtained from the read signal is effective, on the basis of a change amount of the appearance frequency of the at least one signal component;
a recording device for recording a test-writing data pattern onto the recording medium while changing a recording power; and
a calculating device for calculating an optimum recording power used when said recording device records the data pattern onto the recording medium, on the basis of a jitter which is judged to be effective,
said detecting device detecting an appearance frequency of at least one of a signal component of a plurality of types of marks which are included in a read signal obtained by reading the test-writing data pattern and which have different run lengths and a signal component of a plurality of types of spaces which are included in the read signal and which have different run lengths, with each of the changed recording power,
said judging device judging that a jitter corresponding to a recording power in which the appearance frequency is not less than a reference frequency of the signal component of the mark and space in the at least one signal component if the test-writing data pattern is recorded with the relatively high recording power and each of the changed recording power, at a predetermined ratio or more.

17. The recording apparatus according to claim 16, wherein
said detecting device detects an appearance frequency of a signal component of a mark with the shortest run length, and
said judging device judges whether or not the jitter obtained from the read signal is effective, on the basis of a change amount of the appearance frequency of the signal component of the mark with the shortest run length.

18. The recording apparatus according to claim 16, wherein
said detecting device detects an appearance frequency of a signal component of a space with the shortest run length, and
said judging device judges whether or not the jitter obtained from the read signal is effective, on the basis of a change amount of the appearance frequency of the signal component of the space with the shortest run length.

19. The recording apparatus according to claim 17, wherein said judging device judges that the jitter obtained from the read signal is not effective if the appearance frequency is less than a predetermined reference frequency at a predetermined ratio or more.

20. A recording method comprising:
a detecting process of detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths;
a judging process of judging whether or not a jitter obtained from the read signal is effective, on the basis of a change amount of the appearance frequency of the at least one signal component;
a recording process of recording a test-writing data pattern onto the recording medium while changing a recording power; and
a calculating process of calculating an optimum recording power used when said recording process records the data pattern onto the recording medium, on the basis of a jitter which is judged to be effective,
said detecting process detecting an appearance frequency of at least one of a signal component of a plurality of types of marks which are included in a read signal obtained by reading the test-writing data pattern and which have different run lengths and a signal component of a plurality of types of spaces which are included in the read signal and which have different run lengths, with each of the changed recording power,
said judging process judging that a jitter corresponding to a recording power in which the appearance frequency is not less than a reference frequency of the signal component of the mark and space in the at least one signal component if the test-writing data pattern is recorded with the relatively high recording power and each of the changed recording power, at a predetermined ratio or more.

21. A computer-readable medium containing a computer program for recording control and for controlling a computer provided in a recording apparatus comprising: a detecting device for detecting an appearance frequency of at least one of a signal component of a plurality of types of marks which are included in a read signal obtained by reading a data pattern from a recording medium and which have different run lengths and a signal component of a plurality of types of spaces which are included in the read signal and which have different run lengths; a judging device for judging whether or not a jitter obtained from the read signal is effective, on the basis of a change amount of the appearance frequency of the at least one signal component; a recording device for recording a test-writing data pattern onto the recording medium while changing a recording power; and a calculating device for calculating an optimum recording power used when said recording device records the data pattern onto the recording medium, on the basis of a jitter which is judged to be effective, said detecting device detecting an appearance frequency of at least one of a signal component of a plurality of types of marks which are included in a read signal obtained by reading the test-writing data pattern and which have different run lengths and a signal component of a plurality of types of spaces which are included in the read signal and which have different run lengths, with each of the changed recording power, said judging device judging that a jitter corresponding to a recording power in which the appearance frequency is not less than a reference frequency of the signal component of the mark and space in the at least one signal component if the test-writing data pattern is recorded with the relatively high recording power and each of the changed recording power, at a predetermined ratio or more, said computer program making the computer function as said detecting device, said judging device, said recording device, and said calculating device.

22. The recording apparatus according to claim 18, wherein said judging device judges that the jitter obtained from the read signal is not effective if the appearance frequency is less than a predetermined reference frequency at a predetermined ratio or more.
